(19) United States
(12) Patent Application Publication
(10) Pub. No.: US 2026/0290148 A1
(43) Pub. Date: Sep. 24, 2026

(54) SYSTEMS AND METHODS FOR PROVIDING AI-BASED EMERGENCY NOTIFICATIONS

(71) Applicant: RAPIDSOS, INC., New York, NY (US)

(72) Inventor: Andrew Alfred Knitt, Oconomowoc, WI (US)

(73) Assignee: RAPIDSOS, INC., New York, NY (US)

(21) Appl. No.: 19/085,914

(22) Filed: Mar. 20, 2025

(51) Int. Cl. G08B 25/10; G08B 25/00; G10L 15/26

(52) U.S. Cl. CPC G08B 25/10; G08B 25/006; G10L 15/26

(57) ABSTRACT

An emergency response data system (ERDS) provides artificial intelligence (AI)-based emergency notifications to field responders using radio-based dispatches from emergency communications centers (ECCs). The ERDS receives audio data of a radio-based dispatch of emergency responders of an emergency communication, provides the audio data to an AI model with a prompt to transcribe the audio data into a radio dispatch transcript, provides the radio dispatch transcript to the AI model with a further prompt to analyze the radio dispatch transcript to extract activation notification content from the transcript, and receives operating instructions for the plurality of field responders based on the activation notification content. The ERDS provides a notification to an emergency response application for displaying the first set of operating instructions to a first field responder and provides a second notification to a further emergency response application for displaying the second set of operating instructions to a second field responder.

### TECHNICAL FIELD

This disclosure relates generally to emergency management systems, and in particular to expedited and enhanced delivery of emergency notifications to the appropriate emergency agencies, including the transmission of “pre-alert” notifications to additional agencies that may be requested in the event of incident escalation. This proactive approach ensures that all necessary parties are informed and prepared to take action, ultimately leading to a more coordinated and efficient emergency response.

### BACKGROUND

Mutual aid agreements are utilized by emergency responders to facilitate assistance across jurisdictional boundaries. These agreements are implemented in scenarios where an emergency, such as a disaster or multiple-alarm fire, exceeds the capacity of local resources. Mutual aid can be informal and requested solely in emergencies or formalized through agreements that provide continuous cooperation. These formal agreements are often referred to as “automatic aid agreements” and ensure that the nearest resources are dispatched, irrespective of jurisdictional boundaries. Furthermore, mutual aid can also extend beyond local and state boundaries, as exemplified by systems utilized in organizations such as the Mutual Aid Box Alarm System (MABAS), a regional system headquartered in Illinois with 1,500 member fire departments across six states.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an exemplary standardized operating instructions card for mutual aid emergency response instructions, such as a MABAS box card, in accordance with embodiments of the disclosure.

FIG. 2 illustrates an example system diagram of an emergency response environment that provides artificial intelligence (AI)-based emergency notifications to field responders, in accordance with embodiments of the disclosure.

FIG. 3 illustrates an example diagram of an emergency notification environment that is operable to provide an emergency notification using one or more AI models to analyze radio dispatched emergency response requests received from an ECC, in accordance with aspects of the disclosure.

FIG. 4 illustrates an example incident notification card for mutual aid emergency response (e.g., MABAS) activation, according to an embodiment.

FIG. 5 illustrates a diagram of a process for providing AI-based emergency notifications to field responders using radio-based dispatches, in accordance with aspects of the disclosure.

FIG. 6 illustrates an example of an AI prompt instruction and response that may be provided by one or more disclosed systems and/or processes to generate content for emergency notifications for field responders, in accordance with aspects of the disclosure.

FIG. 7 illustrates an example of an AI response that may be provided by one or more disclosed systems and/or processes to generate content for emergency notifications for field responders, in accordance with aspects of the disclosure.

FIG. 8 illustrates an example diagram of an emergency response environment, in accordance with embodiments of the disclosure.

FIGS. 9A and 9B illustrate examples of additional AI prompt instructions that may be provided by one or more disclosed systems and/or processes to generate content for emergency notifications for field responders, in accordance with aspects of the disclosure.

### DETAILED DESCRIPTION

Various aspects of the disclosure include systems, devices, media, algorithms, and methods for providing emergency notifications, such as alerts, between operations centers and first responders using radio-based dispatches. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A public emergency services agency may be established to provide a variety of services. A public emergency services agency can include a 911 call center, a railway call center, a primary call center, a secondary call center (e.g., that receives calls from or routes calls to a primary call center), and the like. A public emergency services agency may be referred to as an emergency service provider (ESP) or an emergency communications center (ECC). One type of ESP or ECC is a public safety answering point (PSAP). A PSAP is another name for a 911 call center that receives emergency calls and dispatches emergency responders in response to the emergency (e.g., 911) calls.

As used herein, a first responder may refer to a firefighter, an emergency medical technician, a paramedic, a police officer, a peace officer, an emergency medical dispatcher, a search and rescue team member, a hazardous materials (HazMat) responder, volunteer emergency workers, and/or public health officials. The systems, processes, and overall technologies disclosed herein may be applicable or implemented for one or more of the various types of first responders, despite some specific examples being directed to firefighters and/or medical service providers for illustrative purposes.

As used herein, an emergency response request may refer to an initiated emergency communication (e.g., a 911 call, a textual message to 911, etc.), a radio-based dispatch of first responders, and/or a computer-aided dispatch (or CAD-based dispatch) of first responders.

As used herein, operations centers refers to private operations centers that oversee, monitor, and/or manage security and emergency incidents across one or more related premises. Common types of operations centers (OC) that may, at least partially, coordinate response to security and emergency incidents include global security operations centers (GSOCs), railway network operations centers (NOCs), emergency operations centers (EOCs), cybersecurity operations centers (CSOCs), traffic operations centers (TOCs), energy or utility operations centers (UOCs), healthcare command centers, aviation operations centers, and maritime operations centers.

First responding agencies, such as, for example, fire departments, may utilize land mobile radio (LMR) based voice paging for incident notification. As will be described in greater details below, communication devices such as radios and pagers may be tuned to a specific dispatch or paging frequency, channel, or talkgroup and silently listens for a station tone, digital signal, or other activation method (e.g., a station-specific audio tone, tone pattern, tone sequence, “tone-out” audio dispatch, etc.) that is sent over the air by the dispatch center. For instance, methods like P25 talkgroup paging/alerting, unit call alerts, etc. may be implemented. When the agency's specific audio tone pattern is detected, the radio or pager may generate an alerting tone to notify the user and then open the communication device's audio path so that a user at the agency can hear the voice dispatch that follows the tone pattern.

These specific audio tone patterns may be provided by one or more emergency response systems capable of notifying and coordinating response information via CAD messages to mobile devices or landlines without dispatch involvement, such as through the use of mobile applications and websites. For instance, these emergency response systems offer the ability to forward radio dispatches that have been detected to their respective mobile apps and websites, making these audio dispatches available to responders that are not carrying radios or pagers or that are outside of radio or pager coverage areas.

Users of these emergency response systems might generally want to receive all audio dispatch notifications for their agency or station. While many users are also interested in knowing about significant incidents in neighboring jurisdictions, these users may not want to be alerted to every routine incident that neighboring departments respond to.

Accordingly, various embodiments of the disclosure enable keyword-based notifications by transcribing the radio dispatch audio. For example, a user could set up a keyword notification so that they may be sent a notification if a neighboring department's dispatch audio contains a specific word or collection of words, such as “structure fire,” “house fire,” “brush fire,” etc. These keyword-based notifications allow users to have additional situational awareness about incidents occurring around them that they are likely to be dispatched to as mutual aid without having to be notified of every routine incident in neighboring jurisdictions. Overall, embodiments of the disclosure improve situational awareness for emergency response systems and first responders, and can lead to reduced response times and improved staffing levels for mutual aid requests, as the requested mutual aid agencies would have some advance notice that they may be requested and may start to plan accordingly.

In the example described pertaining to mutual aid response systems (e.g., MABAS) the various embodiments of the disclosure for pre-alerting may utilize features such as, but not limited to, detecting of radio dispatches, transcribing of the radio dispatches, artificial intelligence (AI)-based parsing and structuring of the radio dispatch information, and knowledge of pre-determined response plans. One of the core concepts of a mutual aid response system is that each member agency may develop preplanned, standardized operating instructions cards, or “box cards,” that may detail response plans for requesting mutual aid resources based on an assessment of an emergency (e.g., alarm level, emergency type, keyword-based notifications, etc.). For example, resources may include staffing availability, emergency unit types and vehicle counts, special equipment, interdivisional requests, etc., from multiple agencies throughout multiple jurisdictions. In other words, a box card may include a predetermined list of apparatus from various fire stations or other emergency services that will be dispatched to the incident at a location. Box card information may also vary based on time of day, incident type, weather, hydranted areas vs. non-hydranted areas and any other potential situations.

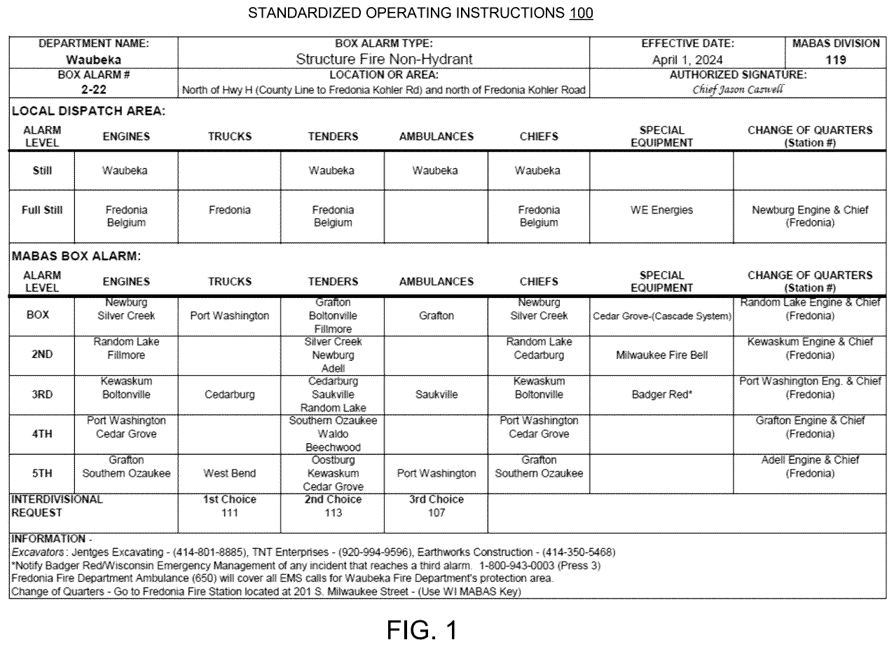

FIG. 1 shows an illustration of an exemplary standardized operating instructions card 100 (e.g., a MABAS box card) mutual emergency response instructions. As opposed to having an incident commander list over the radio each mutual aid resource that they would like to have sent to an incident, the incident commander may request a specific box card that the dispatcher can look up and determine which resources are being requested.

According to one exemplary embodiment, when a fire department is responding to a large incident and needs to request additional resources, the incident commander may request a “Box Alarm” activation. The request may be made over the radio to the local dispatch center of the fire department. The incident commander may then notify the dispatcher of which box card number as well as which level is being requested. In the standardized operating instructions card 100 depicted in FIG. 1, the incident commander may request box card for Box Alarm #2-22 to a specific Box Alarm Level based on the Box Alarm Type. As noted in the exemplary card 100, each of the box alarm levels may indicate a requested set of resources, such as the type of vehicle and personnel (engines, trucks, tenders, squads, ambulances, chiefs, etc.) as well as the location (e.g., dispatch centers) of the requested resources.

In many cases, the resources being requested may be dispatched by other dispatch centers because the resources are coming from different cities or counties. Instead of requiring the requesting dispatch center to make a phone call to each dispatch center that they are requesting resources from, all dispatch centers that are part of mutual organization (e.g., MABAS) may utilize a common radio frequency, such as the Interagency Fire Emergency Radio Network (IFERN) frequency (e.g., 154.2650 MHz) or the recently designated IFERN2 frequency (e.g., 154.3025 MHz), for communication during mutual response activations. Accordingly, the requesting dispatch center may send out an audio dispatch page using specific paging tones (e.g., station tones). Radio receivers in the other dispatch centers of the organization may activate when the paging tones are detected. The requesting dispatch center may then read a script that informs the other dispatch centers which box card and resources are being requested.

As will be described in greater detail below, neighboring dispatch centers may then dispatch the resources that they are responsible for using the local dispatch and paging frequencies. It is understandable for there to be a delay of anywhere from 30 seconds to several minutes from when the IFERN broadcast goes out to when the requested fire departments are actually dispatched. These delays may be human-induced as the dispatchers follow their procedures for entering the information into CAD, looking up information, etc.

Emergency response and dispatch platforms may include features for detecting paging tones on the IFERN radio frequency and sending the recorded dispatch audio to the platform users. However, because the IFERN paging tones are intended for communication between dispatch centers and not for direct field responder notification of incidents, the tones may be the same for all incidents in all jurisdictions. In the exemplary MABAS organization, field responders may not want to be notified of every MABAS activation within radio range. Instead, field responders may only want to know about activations that are relevant to them and their jurisdiction. Various embodiments of the disclosure allow for the IFERN voice dispatch to be transcribed and parsed with AI to determine which agencies are being requested to send resources. Accordingly, transmission of notifications may be limited to only those agencies. Furthermore, these notifications may be automated and, in some cases, may arrive to the field responders in advance of when they get dispatched by their local dispatch center.

The transcriptions noted above for voice dispatch information may have difficulties with unusual places, agency names, etc. However, proper transcription of place and agency names is critical for this type of feature to work reliably. Various embodiments of the disclosure note that including these place and agency names in the transcription prompt or in a subsequent “correction prompt” for AI may significantly improve the results. Additional embodiments may utilize AI structuring of the data to allow notifications to be sent to an agency informing them exactly which type of resource is being requested from them (an Engine, Ambulance, etc.). According to these embodiments, the audio dispatch may also be sent to agencies so that they can listen to it and determine for themselves what is being requested.

As noted above, public emergency services agencies, such as ESPs or ECCs, may use radio-based transmissions to dispatch (e.g., request emergency services to a location) first responders. These radio-based dispatches are sent very shortly after 911 calls are made and represent near real-time information about an emergency (e.g., location, time, type of emergency, severity, etc.). This incredibly valuable information can be masked by low-quality audio, ambiguous addresses, and/or jargon that is specific to emergency response. To address these issues and provide operations centers with up-to-date information about relevant emergencies, embodiments of the disclosure include systems and methods for providing artificial intelligence (AI)-based emergency notifications to operations centers using the radio-based dispatches.

According to one or more various embodiments of this disclosure, an emergency response data system (ERDS) performs a number of operations to generate AI-based emergency notifications. The ERDS may receive a dispatch audio data file from a detector (e.g., a radio wave receiver or transceiver) that converts dispatches into audio data and saves the audio data into audio files. The ERDS may extract metadata, such as, the source ECC for the dispatch, the (intended) destination first responder station, a time stamp, a location of the detector that received the radio dispatch. The ERDS may condition the audio data by removing background noise, tones, and silences, for example. The ERDS may determine a geographical bias or bias region associated with (e.g., that includes) the source ECC or destination first responder station. The ERDS may use the bias region to query a mapping service for potential street names within the bias region. The ERDS may use an AI model (or transcription service) to transcribe the audio data. The AI model may be trained with historical dispatch data (e.g., transcripts or computer-aided dispatch data). The transcript may be searched for names that may be part of an address or emergency location. One or more phonetical functions or analyses may be applied to the potential street names and/or searched names. Phonetical analysis may include encodings (Soundex, Metaphone, NYSIIS) and similarity metrics (e.g., Levenshtein distance, Jaro-Winker, phonetic code comparison, etc.). Phonetical matches between the potential street names may be provided to an AI model as potential addresses to facilitate accurate location extraction.

The ERDS may apply the transcript of the radio dispatch to an AI model to generate various types of AI-based output. The AI-based output may include a location of the emergency, a transcript of the dispatch, a type of the emergency, and/or a summary of the dispatch. The ERDS may provide the bias region, the potential street names, the searched names, and/or the phonetical matches as context for prompt instructions “prompts” provided to the AI model. One or more detailed prompts may be provided to the AI model to generate content (e.g., AI-based output) for the AI-based emergency notifications.

The AI-based output may be provided to an operations center emergency response application as part of an (AI-based) emergency notification. The emergency response application may display the location of the emergency as text, as a point on a map, and/or by highlighting a premises (e.g., building, structure, etc.). The ERDS may host the emergency response application and push updates to a remote instance of the application via an Internet-based connection with the instance.

Overall, embodiments of the disclosure improve the technology area of 911 service systems and emergency response systems by improving and expanding the recipient pool of emergency notifications to include operations centers and field responders. Mutual aid organizations allow for the distribution of situational instructions through the use of “box cards,” however, these cards are currently distributed in PDF format and are typically updated once per year. Extracting the information from the box cards into a standard, structured format, such as a JavaScript Object Notation (JSON) format, for storage and programmatic usage will require preprocessing. It is noted that while the preprocessing may involve AI, it is understood that the preprocessing may also be able to be done using more traditional OCR and table extraction techniques. Additionally, real-time transcription could reduce notification times even further. For instance, standard information such as the requesting agency, box card number, alarm level, etc., may all be given at the beginning of the voice dispatch. After that, the dispatcher may then list out all resources that are being requested, which takes additional time. A real-time transcription may allow the system to start looking up the information from the box card and sending notifications much sooner, such as, while the dispatcher is still talking rather than waiting for the recording to finish before transcription starts. Thus, coordinating with multiple agencies, ECCs and first responders, early notification of, for example, a mutual aid, multi-jurisdiction emergency may enable operations centers and field responders to reduce property damage, save lives, and reduce injuries to first responders arriving at the scene of an emergency.

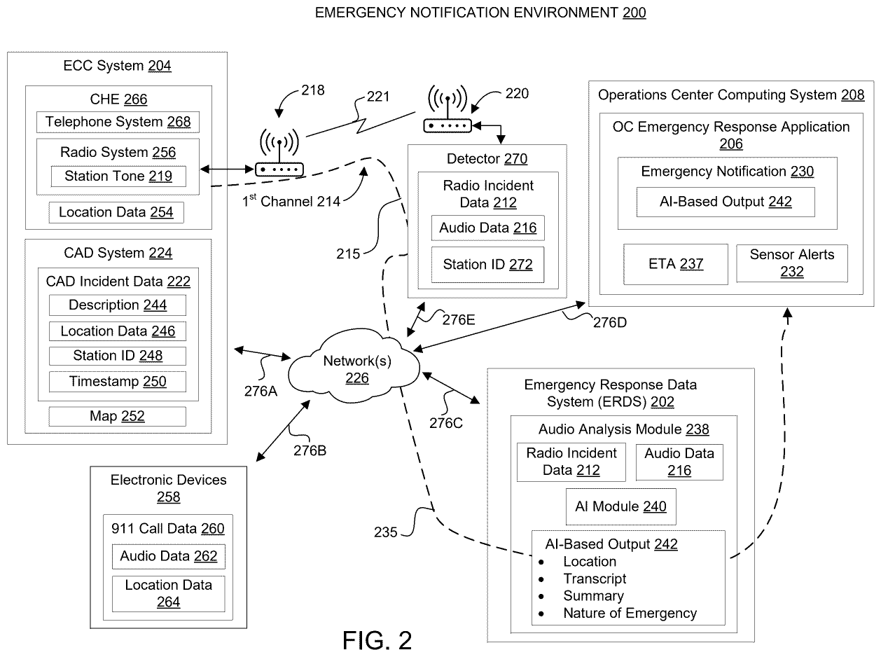

FIG. 2 illustrates an example system diagram of an emergency notification environment 200 that provides artificial intelligence (AI)-based emergency notifications to field responders using radio-based dispatches, in accordance with aspects of the disclosure. Emergency notification environment 200 includes an emergency response data system (ERDS) 202 that is operable to receive emergency response requests (e.g., a dispatch) over one or more channels from an ECC system 204 and is operable to provide an AI-based analysis of radio-based requests/dispatches to generate and provide notification of an emergency at one or more premises managed by an operations center, in accordance with aspects of the disclosure. One channel may be at least partially based on an over-the-air radio transmission (e.g., in the VHF or UHF bands) from a dispatcher, and another of channel may at least partially be from a computer-aided dispatch (CAD) system 224. Because operations centers (e.g., a GSOC, train NOC, etc.) may be unaware of emergency calls (e.g., calls to 911), operations centers may be unable to provide resources (e.g., onsite security, onsite medical, etc.) to the location of an emergency call. Additionally, first responders may need access to buildings, gates, or other access points that could be opened prior to the arrival of the first responders, had an operations center known of the time, place, and/or nature of emergency calls made from the premises managed by the operations center. Various embodiments of the disclosure enable AI-based emergency notifications using radio-based dispatches that can be monitored over-the-air and analyzed.

ERDS 202 receives and analyzes emergency response requests (e.g., radio-based dispatches) to support generating an emergency notification 230 for operations center computing system (OCCS) 208, in accordance with aspects of the disclosure. ERDS 202 is configured to receive radio incident data 212 over a first channel 214. First channel 214 may have a path 215 that extends from ECC system 204 to detector 270, to ERDS 202, and to OCCS 208. First channel 214 at least partially includes radio transmission of audio data 216 from a radio 218 to a radio 220. Radio 218 may be a UHF and/or VHF radio transceiver that is operated by a dispatcher or telecommunicator at an ECC. Radio 220 may be a radio receiver or scanner that is configured to receive audio transmissions from radio 218 over one or more frequencies. Radio incident data 212 includes an over-the-air emergency response request that may initially be an audio recording of a dispatched incident (e.g., represented as audio data 216). Radio incident data 212 may also include a time stamp and a station ID 217 that identifies the one or more dispatched stations (e.g., fire station, emergency medical services, etc.). The station ID 217 may be determined based on a station tone 219 used during the radio communications that provide the emergency response request. ERDS 202 may analyze/compare radio incident data 212 and CAD incident data 222 to determine if one source of incident data is duplicative of the other and/or to perform error correction. ERDS 202 analyzes content of audio data 216 and provides AI-based output 242 to operations center (OC) emergency response application 206, in accordance with aspects of the disclosure.

ERDS 202 may include an audio analysis module 238 to provide emergency notification 230 to OC emergency response application 206, according to an embodiment. Audio analysis module 238 may generate emergency notification 230 based on audio processing, transcribing, AI analyzing, and/or formatting audio data 216, according to an embodiment. Audio analysis module 238 may generate emergency notification 230 without transcribing audio data 216 and instead may apply audio data 216 directly to one or more AI models (e.g., AI module 240) to generate at least parts of emergency notification 230. Audio analysis module 238 may be configured to extract audio data 216 from radio incident data 212 and apply audio data 216 to an AI module 240 to generate AI-based output 242, according to an embodiment. AI module 240 may include one or more of: a transcription tool, a transcription service, a large language model (LLM), one or more machine learning algorithms, and/or an AI model, in accordance with various aspects of the disclosure. Audio analysis module 238 may provide audio data 216 and one or more prompts to AI module 240 (e.g., one or more AI models) to generate AI-based output 242, according to an embodiment.

AI module 240 may be implemented using one or more of a variety of technologies. AI module 240 may be a service that emergency response data system 202 communicates with remotely or may include a number of libraries and software packages installed onto one or more local or distributed server (e.g., cloud) systems. AI module 240 may be implemented using transfer learning models that apply knowledge learned from one task to another, typically using pre-trained models. Examples of transfer learning models that may be used include, but are not limited to, BERT (bidirectional encoder representations from transformers): a transformer-based model for natural language processing tasks; GPT (generative pre-trained transformer): a generative model for text-based tasks; and ResNet: a pre-trained deep learning model commonly used for image classification. AI module 240 may incorporate other types of models, such as deep learning models, unsupervised models, generative models, recommender systems, or the like. Examples of deep learning models may include convolutional neural networks (CNN), which may be used for image recognition tasks; recurrent neural networks (RNN), which may be used for sequential data, such as time series or natural language; and long short-term memory networks (LSTMN), for example.

AI module 240 may be implemented using one or more large language models (LLMs), according to an embodiment. LLMs are AI models that are trained to understand and generate human language. LLMs use large amounts of text data to learn patterns, context, and meaning in language. Examples of LLMs include, but are not limited to, generative pre-trained transformers (GPTs), BERT, DistilBERT, T5 (Text-to-Text Transfer Transformer), XLNet, Turing-NLG, LLaMA (Large Language Model Meta AI), Claude, PaLM (Pathways Language Model), Megatron-Turing NLG, ChatGPT, OpenAI Codex, ERNIE (Enhanced Representation through Knowledge Integration), and/or Grok.

ERDS 202 is configured to receive CAD incident data 222 from a CAD system 224 over one or more networks 226, according to an embodiment. CAD incident data 222 includes, but is not limited to, a description 244, location data 246, a station ID 248, and a timestamp 250, according to embodiments of the disclosure. Location data 246 and/or other CAD incident data 222 may be displayed or otherwise represented on a map 252 of CAD system 224.

ERDS 202 may be configured to receive CAD incident data 222 over a second channel 234. The second channel 234 is a CAD-based transmission/reception of an emergency request response, according to an embodiment. ERDS 202 may support a number of application programming interfaces (APIs) that enable CAD system 224 to transmit/receive incident data for emergency response requests. The second channel 234 includes a data path 235 that extends from CAD system 224, extends to ERDS 202 through one or more networks 226, and extends to emergency response application 206, according to an embodiment. CAD incident data 222 includes an emergency response request (e.g., inclusive of description 244, location data 246, and/or station ID 248) that may initially become available from CAD system 224 and be dispatched electronically to, for example, ERDS 202. ERDS 202 may evaluate radio incident data 212 and CAD incident data 222 and selectively train one or more AI models for accuracy improvement.

Emergency response requests may be initiated with electronic devices, according to an embodiment. Electronic devices 258 represent smart phones, smart watches, tablets, laptops, computer systems, or the like. Electronic devices 258 may initiate an emergency response request with various types of emergency communication, such as a 911 call, a textual message to 911, a panic button, or the like. Electronic devices 258 may then provide 911 call data 260 to ECC system 204 using one or more cellular networks or other networks 226. The 911 call data 260 may include audio data 262 and location data 264. The audio data 262 is representative of the information a caller audibly (or text-based) provides to ECC system 204 during, for example, a conversation with a telecommunicator, in one embodiment. The location data 264 may represent device-based location data (e.g., GPS, other satellite network, wireless router location, etc.) or may represent automated location information (ALI) data that is at least partially generated/provided by a cellular tower as an estimated location of an electronic device.

ECC system 204 provides tools for call-takers, dispatchers, or other telecommunicators to interact with emergency number callers (e.g., users of electronic devices 258). ECC system 204 may include call handling equipment (CHE) 266 and CAD system 224 to support delivery of emergency response requests to first responder devices and/or to OCCS 208. CHE 266 may include a telephone system 268 and radio system 256 (inclusive of radio 218) for receiving 911 call data 260 and for communicating radio incident data 212, according to an embodiment. Telephone system 268 may include one or more landlines and one or more voice over IP (VoIP) lines. A telecommunicator may use radio system 256 to broadcast an over-the-air emergency response request to one or more emergency responders 210. As part of dispatching an over-the-air emergency response request, radio system 256 may emit a station tone 219 and audio data 216 with radio 218 over ultra-high frequency (UHF) and/or very-high frequency (VHF) bandwidths. Station tones can be associated with one or more particular stations or types of emergency responders 210 (e.g., firefighter, emergency medical services, police officers, etc.). For example, within a county a first fire station may be assigned or associated with a first tone sequence, a second fire station may be assigned or associated with a second tone sequence, and all fire stations within the county may be assigned/associated with a third tone sequence. In the same county, a first emergency medical service (e.g., emergency medical technicians (EMTs)) station may be assigned a fourth tone, a second emergency medical service station may be assigned a fifth tone sequence, and the first fire station and the second emergency service station may be assigned a sixth tone sequence, for example. In some counties, a fire station may also serve as an emergency medical service station, so the station may be associated with a single tone sequence or three separate tone sequences, for example.

CAD system 224 may be used in parallel with CHE 266 by telecommunicators to provide emergency response requests to emergency responders 210. CAD system 224 may automatically receive at least part of CAD incident data 222 (e.g., location data 246) from EMS 202 or other emergency data providers, according to one embodiment. CAD system 224 may also receive CAD incident data 222 by a dispatcher or telecommunicator that enters the content of audio data 262 into CAD system 224. CAD incident data 222 includes description 244, location data 246, station ID 248, and timestamp 250. Description 244 may include the type of incident, people involved in the incident, a description of injuries, and the like. Location data 246 may include an address, descriptive location, and/or latitude/longitude coordinates to an incident. The term “address” may be used interchangeably with “descriptive location”. An address or descriptive location may include a street address, a general location, and/or a street address combined with a description or address modifier, such as: in front of 123 Main Street, across the street from 234 Second Street, southwest of the residence on 345 Third Street, on the north end of Bay View Park, etc. Station ID 248 may include an identifier of one or more fire stations or emergency medical services stations that are near the location of an incident or that have jurisdictional responsibility for the location of the incident. The timestamp 250 may provide a date and time for when a call was made to 911 or may refer to when CAD incident data 222 was entered into CAD system 224.

Emergency notification environment 200 may include detector 270 that is operable to digitally capture information provided by radio 218 and received by radio 220, according to an embodiment. Detector 270 may be communicatively coupled to radio 220, and radio 220 may be strategically located where radio waves 221 may be detected from radio 218 (e.g., away from a station or home of an emergency responder). It is noted that in some embodiments, the functions of the detector 270 and the radio 220 may be combined into a single component, such as when using a software-defined radio (SDR) receiver. Detector 270 may be configured to generate radio incident data 212 based on the information provided with radio system 256. Radio incident data 212 may include audio data 216 and station ID 272. Audio data 216 may be a recording (in a digital format) of an emergency response request that was transmitted/dispatched using radio 218. Station ID 272 may be determined by detector 270 based on the station tone 219 transmitted by radio system 256/radio 218. In one embodiment, radio 220 and detector 270 are aspects of ERDS 202, according to an embodiment.

Emergency response application 206 enables field responders and operations center operators to receive emergency notification 230 of on-premises or onsite initiated emergency communications, according to an embodiment. Emergency notification 230 may include an address of an emergency, a graphical representation of the location of the emergency, an AI-based summary of the emergency, a transcript of the dispatch, and/or the nature of the emergency. Emergency notification 230 may include or be displayed with AI-based output 242, an estimated time of arrival (ETA) 237, and/or one or more sensor alerts 232. A user interface of the emergency response application may include one or more maps or floorplans, and the location of the dispatched emergency may be displayed on the maps and/or floorplans. Sensor alerts 232 is representative of one or more smart sensors associated with the managed premises, telematics data from nearby vehicles, medical data from people near the managed premises, weather data, traffic data, and/or other data sources that ERDS 202 may receive and aggregate to provide further context of an initiated emergency communication, according to an embodiment.

Networks 226 may be communicatively coupled to various components of emergency notification environment 200 using a number of communications channels 276. For example, a communications channel 276A may communicatively couple ECC system 204 to the one or more networks 226. A communications channel 276B may communicatively couple electronic devices 258 to the one or more networks 226. A communications channel 276C may communicatively couple ERDS 202 to the one or more networks 226. A communications channel 276D may communicatively couple OCCS 208 to the one or more networks 226. A communications channel 276E may communicatively couple detector 270 to the one or more networks 226, for example. Communications channels 276A, 276B, 276C, 276D, and 276E may be collectively referred to as communications channels 276, which may enable the various components of emergency notification environment 200 to communicate with each other.

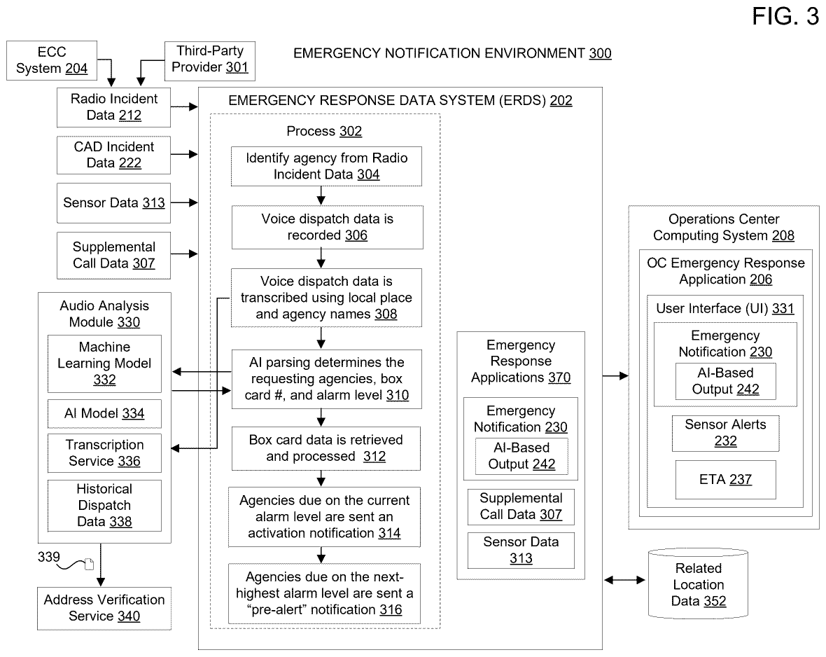

FIG. 3 illustrates an example diagram of an emergency notification environment 300 that is operable to provide an emergency notification using one or more AI models to analyze radio dispatched emergency response requests received from an ECC, in accordance with aspects of the disclosure. Emergency notification environment 300 is an example implementation of emergency notification environment 200, according to embodiments. Emergency notification environment 300 may run a process 302 in/with ERDS 202. ERDS 202 may be organized as one or more software modules including one or more processes, such as process 302 and/or other processes disclosed herein. Process 302 and/or ERDS 202 transform input data (e.g., radio incident data 212, CAD incident data 222, sensor data 313, and/or supplemental call data 307) into emergency notification 230 and/or AI-based output 242, in accordance with various aspects of the disclosure.

Process 302 may include a number of operations for generating AI-based output 242 for emergency notification 230 using radio-based dispatches, in accordance with aspects of the disclosure. The order in which some or all of the process operation blocks appear in process 302 should not be deemed limiting. Rather, one of ordinary skill in the art having the benefit of the present disclosure will understand that some of the process blocks may be executed in a variety of orders not illustrated, or even in parallel. The operations of process 302 may be performed by a particular system (e.g., emergency responder notification system 304) or may be distributed between various subsystems or modules in ERDS 202 and/or in emergency notification environment 300, according to various embodiments. Furthermore, the operations of process 302 may be performed iteratively. According to one embodiment, an exemplary AI prompt may allow the AI module 240 to call “tools” or “functions” to gather additional information that may be used to improve the results of the transcription, which box card to use, etc. For example, once the AI module 240 has determined (e.g., from the audio) which MABAS division is requesting the alarm, the AI module 240 can call a function to get the names of all fire departments in that division, which can then be used to correct transcription results. Similarly, once the AI module 240 has determined which department within the division is making the request, the AI module 240 can retrieve that agency's box cards for further context.

At operation 304, process 302 identifies an emergency agency based on radio incident data 212, according to an embodiment. For instance, ERDS 202 may receive an emergency response request represented by radio incident data 212, which includes audio data for a radio-based dispatch from an ECC about an initiated emergency communication as well as paging tone or station tone data 219. Radio incident data 212 may represent a radio-based dispatch from ECC system 204 about an initiated emergency communication (e.g., 911 call, textual message to 911), in one embodiment. Radio incident data 212 may be received from a third-party provider 301 that detects and records various radio-based dispatches across the country and/or world. ERDS 202 may process audio data from various radio-based dispatches to determine the nature of the emergency, to generate a summary of the dispatch, to determine a location of the initiated emergency communication, and/or to generate transcripts of the dispatches, in accordance with aspects of the disclosure. Radio incident data 212 may include incident data that was at least partially recorded with a detector that is coupled to a scanner to receive a radio-based dispatch from an ECC. Operation 304 may proceed to operation 306.

At operation 306, process 302 records audio data (e.g., voice dispatch data) from the emergency response request (e.g., radio incident data 212), according to an embodiment. Audio data may include/represent recording of a dispatch of an incident that is captured by the detector and provided to ERDS 202. Furthermore, the audio data may also be conditioned. Conditioning the audio data may include, but is not limited to, metadata retrieval from the audio file (e.g., time stamp, duration, detector ID, station ID, etc.), audio cleaning, and/or determining a bias region (e.g., location of emergency agency that sent a dispatch or that is the intended recipient of the dispatch).

Audio cleaning may include operations on the audio data to enhance the audio data quality for transcription. One or more software functions may be used to remove background noise, tones, and silences. Parameters similar to a silence_thresh (e.g., the minimum volume threshold to identify non-silence) and min_silence_len (e.g., the minimum duration to consider a segment as silence) may be configured to further improve the cleaning process. The cleaned audio may be subsequently saved as a new file, ready transcription and/or further processing.

Determining a bias region may be performed with one or more functions that operate on metadata of the audio data file and/or radio incident data 212. In one embodiment, a bias region is determined based on analysis of content of the audio data. The bias region generally refers to a location of an emergency agent (e.g., an ECC or a first responder station that is the intended recipient of a dispatch). The bias region may be defined as a predetermined radius (e.g., 10 km) around the emergency agent, according to one embodiment. The center of the bias region may be defined by the latitude (e.g., bias_lat) and longitude (e.g., bias_lon) of the bias point. This phase ensures the audio data is prepared, cleaned, and enriched with metadata for accurate transcription and subsequent processing. Operation 306 may proceed to operation 308.

At operation 308, process 302 transcribes the audio data using local place and agency names, according to an embodiment. One or more AI models and/or transcription services may be used to directly analyze the audio data or to initially generate a transcript of the audio data. One or more transcription engines or services that may or may not leverage an artificial intelligence (AI) model may be used to transcribe the audio, in accordance with various implementations of the disclosure. For instance, transcription service 336 may include commercially available solutions, such as Dragon NaturallySpeaking®, Otter.ai, Sonicx.ai, Descript, Verbit, and/or Google® services. Google Cloud Natural Language service or Google Cloud Speech-to-Text service may enable training of sentiment classification, extraction, and detection by uploading training data, for example.

Emergency notification content may include, but is not limited to, a summary of the audio data, a transcript of the audio data, a nature/type of emergency dispatched, and/or an address/location of the initiated emergency communication that may cause the radio-based dispatch. Furthermore, the process 302 may generate potential address names from related location data (e.g., the bias region), according to an embodiment. Process 302 may provide the bias region to a mapping service, such as OpenStreetMap, Apple Maps, etc., to retrieve the street names within and/or proximate to the bias region. The bias region may be provided to the mapping service using application programming interface (API) calls/functions, and the (list of) street names may be retrieved from the mapping service using API. These potential address/street names may be stored in a database such as related location data 352 and/or may be provided to an AI model to increase the likelihood of accurate location determination.

Furthermore, the address information may be validated. To validate the address from the emergency notification content, operation 312 includes applying the content to an audio analysis module 330 and/or to an address verification service 340, according to an embodiment. Audio analysis module 330 may be used to determine or verify an address from transcribed audio data (e.g., from operation 310) or from audio data. Audio analysis module 330 may include a machine learning model 332, an AI model 334, and/or a transcription service 336—each of which may be trained on historical dispatch data 338 and/or on CAD incident data 222, according to an embodiment. Operation 308 may proceed to operation 310.

At operation 310, process 302 analyzes and parses the audio data to generate emergency response activation notification content, according to an embodiment. Process 302 may provide the audio data to audio analysis module 330 to analyze the audio data, wherein response activation notification content, such as requesting agencies, box card numbers, alarm levels, etc., may be generated. Audio analysis module 330 may include a machine learning model 332, an AI model 334, and/or the transcription service 336—each of which may be trained on historical dispatch data 338 and/or on CAD incident data 222, according to an embodiment. In some implementations, transcription service 336 may include a machine learning model 332 and/or AI model 334. Audio analysis module 330 may be prompted or configured to extract an address from the content that has been transcribed from the audio data. Example prompts may include “determine an address from this text,” for example. Audio analysis module 330 may provide a proposed address 339 to address verification service 340 (e.g., OpenStreetMap®, Google Maps™, Apple Maps™, etc.) for validation. Address verification service 340 may include one or more commercially available address verification services, such as, but not limited to, Google® address verification, Apple Maps™, ETSi maps, or the like.

Process 302 may include various types of prompts to one or more AI models to generate response activation notification content. The AI model output may be referred to herein as AI-based output. Prompts to the AI model and/or to other (e.g., Python) software functions may include, but are not limited to, phonetic analysis using encodings such as: Soundex-handles similar-sounding consonants; metaphone-focuses on English pronunciation patterns; and NYSIIS-accounts for common spelling variations. These encodings may then be analyzed against the transcribed street names using similarity metrics, including: Direct Substring Matching-checks if one string is contained within another; Levenshtein Distance-measures the minimum number of single-character edits required to change one word into another; Jaro-Winkler Similarity-produces a score between 0 and 1, where 1 indicates an exact match; and/or Phonetic Code Comparison-compares the phonetic encodings of both strings. This phonetic analysis may be performed on radio dispatch transcripts by non-AI software and/or may be performed (e.g., using instructive prompts) by one or more AI models.

Those skilled in the art understand that machine learning comprises a branch of artificial intelligence. Machine learning typically employs learning algorithms such as Bayesian networks, decision trees, nearest-neighbor approaches, and so forth, and the process may operate in a supervised or unsupervised manner as desired. Deep learning (also sometimes referred to as hierarchical learning, deep neural learning, or deep structured learning) is a subset of machine learning that employs networks capable of learning (typically supervised, in which the data consists of pairs (such as input data and labels) and the aim is to learn a mapping between the input data and the associated labels) from data that may at least initially be unstructured and/or unlabeled. Deep learning architectures include deep neural networks, deep belief networks, recurrent neural networks, and convolutional neural networks. Many machine learning algorithms (e.g., AI algorithms) build a so-called “model” (e.g., an AI model) based on sample data, known as training data or a training corpus, in order to make predictions or decisions without being explicitly programmed to do so. A variety of different methodologies and models may be employed with these teachings, such as those disclosed herein.

AI model 334 may be implemented using one or more of a variety of technologies. AI model 334 may be a service that emergency response data system 202 communicates with remotely or may include a number of libraries and software packages installed onto one or more local or distributed server (e.g., cloud) systems. AI model 334 may be implemented using transfer learning models that apply knowledge learned from one task to another, typically using pre-trained models. Examples of transfer learning models that may be used include, but are not limited to, BERT (bidirectional encoder representations from transformers): a transformer-based model for natural language processing tasks; GPT (generative pre-trained transformer): a generative model for text-based tasks; and ResNet: a pre-trained deep learning model commonly used for image classification. AI model 334 may incorporate other types of models, such as deep learning models, unsupervised models, generative models, recommender systems, or the like. Examples of deep learning models may include convolutional neural networks (CNN), which may be used for image recognition tasks; recurrent neural networks (RNN), which may be used for sequential data, such as time series or natural language; and long short-term memory networks (LSTMN), for example.

AI model 334 may be implemented using one or more large language models (LLMs), according to an embodiment. LLMs are AI models that are trained to understand and generate human language. LLMs use large amounts of text data to learn patterns, context, and meaning in language. Examples of LLMs include, but are not limited to, generative pre-trained transformers (GPTs), BERT, DistilBERT, T5 (Text-to-Text Transfer Transformer), XLNet, Turing-NLG, LLaMA (Large Language Model Meta AI), Claude, PaLM (Pathways Language Model), Megatron-Turing NLG, ChatGPT, OpenAI Codex, ERNIE (Enhanced Representation through Knowledge Integration), and/or Grok.

In one implementation, audio analysis module 330 iteratively identifies and proposes a potential address from the transcribed audio data at least partially on the related location data (e.g., street names from a mapping service). Audio analysis module 330 may search for key terms such as location, located at, at, and/or address. Audio analysis module 330 may then define 3-5 words that follow (or precede) the key term or that precede the key term to be a potential address or location. Although the term “address” is used to reference the location of an emergency, address may also include relative descriptors such as, “across the street from”, “half a mile north of”, “the south-west corner of”, “behind the building located at”, or the like. Audio analysis module 330 may provide the potential or proposed address 339 to address verification service 340. Of the one or more proposed addresses, audio analysis module 330 may select or return the verified or valid address as the address associated with the transcribed audio data, according to an embodiment. Operation 310 may proceed to operation 312.

At operation 312, process 302 retrieves the box card data, according to an embodiment As detailed above, the process 302 may refer to the standardized operating instructions card 100 (e.g., MABAS card) to determine the appropriate agency or agencies and recommended resources based on the current alarm level for the emergency from the voice dispatch. Operation 312 may proceed to operation 314.

At operation 314, process 302 provides an activation notice to the agencies based on the current alarm level from the emergency notification content, according to an embodiment. Referring back to the standardized operating instructions card 100 (e.g., a MABAS box card) from FIG. 1, AI-assisted notification process 302 may correctly identify the box card being requested as box 2-22. Furthermore, even if an initial IFERN page incorrectly stated “Box 2-2” when it should have been “2-22,” the process 302 may identify and adjust for the discrepancy.

Furthermore, the process 302 may provide an emergency notification to operations center emergency response application 206 to increase visibility at operations centers for emergencies occurring on premises or areas that the operations centers oversee, according to an embodiment. The emergency notification includes AI-based output 242 having one or more of a location of the emergency, a transcript of the radio-based dispatch, a summary of the radio-based dispatch, and/or a nature/type of emergency that are at least partially generated by providing prompts and data and context to one or more AI models. Emergency notification 230, sensor alerts 232, and/or ETA 237 may be displayed by a user interface (UI) 331 of emergency response application 206, according to an embodiment.

One or more of the operations of process 302 may use CAD incident data 222, sensor data 313, and/or supplemental call data 307 to train, supplement, and/or otherwise improve information provided in emergency notification 230, according to various embodiments of the disclosure. CAD incident data 222 may include text-based data for a dispatch that may be concurrently transmitted over-the-air as a radio-based dispatch. CAD incident data 222 may include a type of emergency, a location of the emergency, and a summary of the emergency. ERDS 202 may be configured to compare and contrast AI-generated output (e.g., a type of emergency, a location of the emergency, and a summary of the emergency) with CAD incident data 222 (e.g., a type of emergency, a location of the emergency, and a summary of the emergency) as accuracy feedback for improving the accuracy of the AI model, when CAD incident data 222 is available. Sensor data 313 may be retrieved or received by ERDS 202 an may include, but is not limited to, fire alarm data, smoke sensor data, temperature sensor data, proximity sensor data, moisture sensor data, pressure sensor data, shock sensor data, image sensor data, telematics data, door/window sensor data, and/or ambient conditions data, for example. Supplemental call data 307 may refer to hybrid device-based location data that may be received from telecommunications companies/device manufacturers. For example, a smartphone manufacturer may configure smartphones to temporarily turn on location-based sensors and provide the telephone number, a time stamp, and/or the device location to ERDS 202 when an emergency communication (e.g., call or text to 911) is initiated from the device, according to an embodiment.

ERDS 202 hosts emergency response applications 370 to support delivery of data and experiences to operations centers, ECCs, and/or field responders, in accordance with aspects of the disclosure. Emergency response applications 370 may support Internet-based connections between ERDS 202 and operations centers, ECCs, and/or first responders computing systems. ERDS 202 may provide emergency notification 230, AI-based output 242, and various types of data to emergency response applications 370, which are then pushed to local instances of the application (e.g., emergency response application 206), for example. Operation 314 may proceed to operation 316. It is noted that in some instances, the content of emergency notification 230 may be different when provided to the emergency response applications 370 as compared to the content provided to OCCS 208. For example, the OCCS 208 may be provided with a redacted or summarized version that removes personal information, etc.

At operation 316, process 302 process 302 provides a pre-alert activation notice to one or more additional agencies based on the next-highest alarm level from the emergency notification content, according to an embodiment. More specifically, in addition to identifying the requested agencies for the current activation level, the process 302 may also correctly identify the requested agencies from the stored box card for the next activation level and notify that additional agency or agencies through the use of “pre-alert” notifications.

According to the various embodiments of the disclosure, if an exemplary box card number and alarm level can be extracted from the radio dispatch transcription, the information from that box card may be programmatically referenced to send pre-alert notifications to agencies that will be requested if the incident escalates (e.g., agencies at the next highest alarm level). For example, if the transcription and AI parsing indicates that Box Card 11-12 has been requested to the 2nd alarm level, all agencies on the 3rd alarm level may be sent a pre-alert informing them of the location of the incident and what resources will be requested of them if the incident escalates to the 3rd alarm level. Thus, the process 302 allows those agencies to begin planning, calling in additional staff, etc.

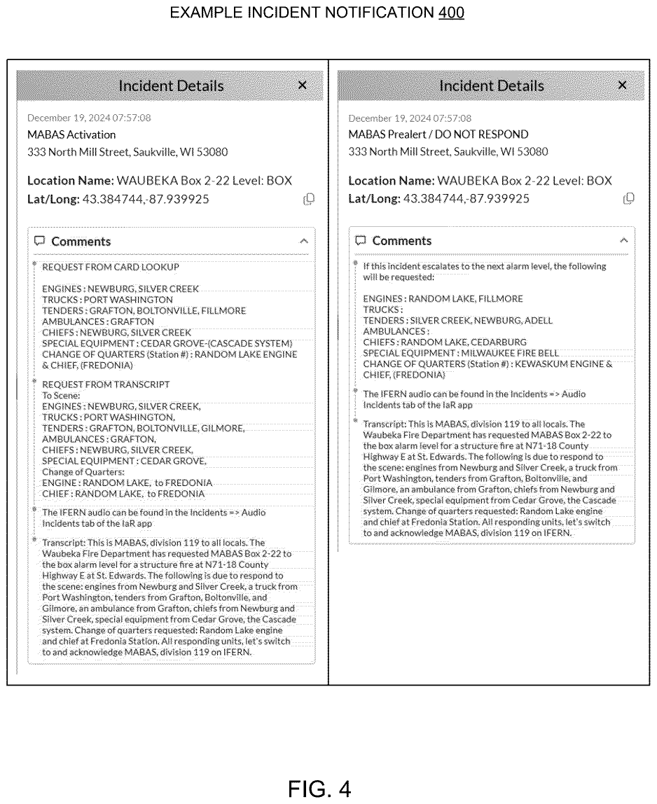

FIG. 4 illustrates an example incident notification card 400 for MABAS activation, according to an embodiment. The details in this exemplary incident notification card 400 include card lookup data, requested resources to the scene, access link/instructions to IFERN audio, and call transcript data.

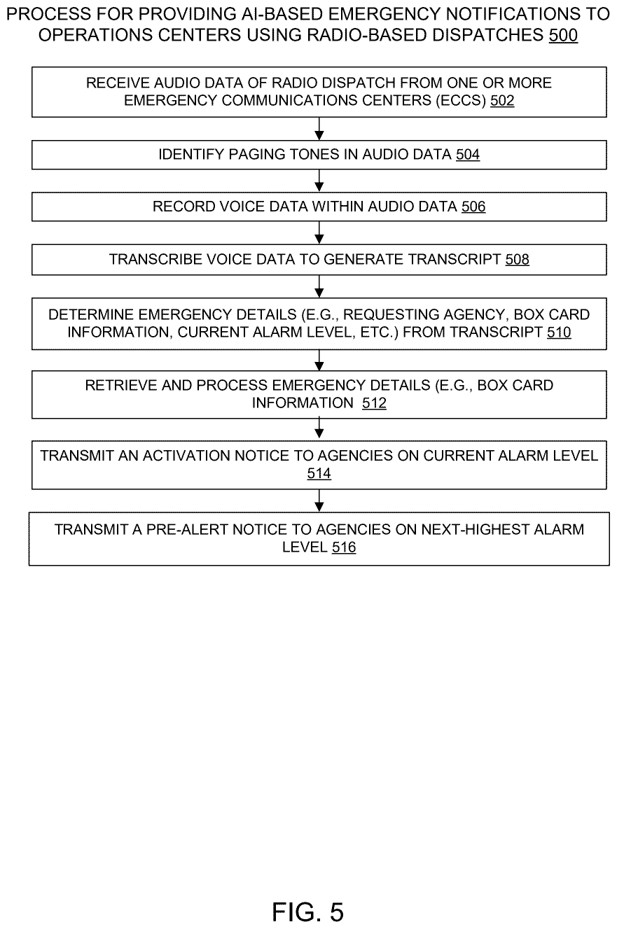

FIG. 5 illustrates a diagram of a process 500 for providing AI-based emergency notifications to field responders using radio-based dispatches, in accordance with aspects of the disclosure. The order in which some or all of the process operation blocks appear in process 500 should not be deemed limiting. Rather, one of ordinary skill in the art having the benefit of the present disclosure will understand that some of the process blocks may be executed in a variety of orders not illustrated, or even in parallel. The operations of process 500 may be performed by a particular system (e.g., ERDS 202) or may be distributed between various subsystems or modules in an ERDS, according to various embodiments. Similar to the operations of process 302 discussed above, the operation of process 500 may be performed iteratively. According to one embodiment, an exemplary AI prompt may allow the AI module 240 to call “tools” or “functions” to gather additional information that may be used to improve the results of the transcription, which box card to use, etc. For example, once the AI module 240 has determined (e.g., from the audio) which MABAS division is requesting the alarm, the AI module 240 can call a function to get the names of all fire departments in that division, which can then be used to correct transcription results. Similarly, once the AI module 240 has determined which department within the division is making the request, the AI module 240 can retrieve that agency's box cards for further context.

At operation 502, process 500 receives audio data of radio dispatch of emergency responders of an initiated emergency communication from one or more emergency communications centers (ECCs), according to an embodiment.

At operation 504, the process 500 identifies a paging or station tone on the radio frequency (e.g., IFERN), according to an embodiment.

At operation 506, process 500 records voice data within the audio data, according to an embodiment.

At operation 508, process 500 transcribes the voice data to generate a transcript, according to an embodiment.

At operation 510, process 500 analyzes the radio dispatch transcript to extract activation notification content from the radio dispatch transcript, according to an embodiment.

At operation 512, process 500 retrieves instructions based on a standardized operating instructions card (e.g., a MABAS box card) based on the extracted activation notification content, according to an embodiment. For instance, process 500 may receive operating instructions for a plurality of field responders based on the activation notification content, wherein a first set of operating instructions correlates to a first alarm level and a second set of operating instructions correlates to a second alarm level (e.g., next highest alarm level), according to an embodiment.

At operation 514, process 500 provides a first AI-based activation notification to an emergency response application that is operable to display the first set of operating instructions to a first field responder, according to an embodiment.

At operation 516, process 500 provides a second AI-based activation notification, or pre-alert notice, to a further emergency response application that is operable to display the second set of operating instructions to a second field responder, according to an embodiment.

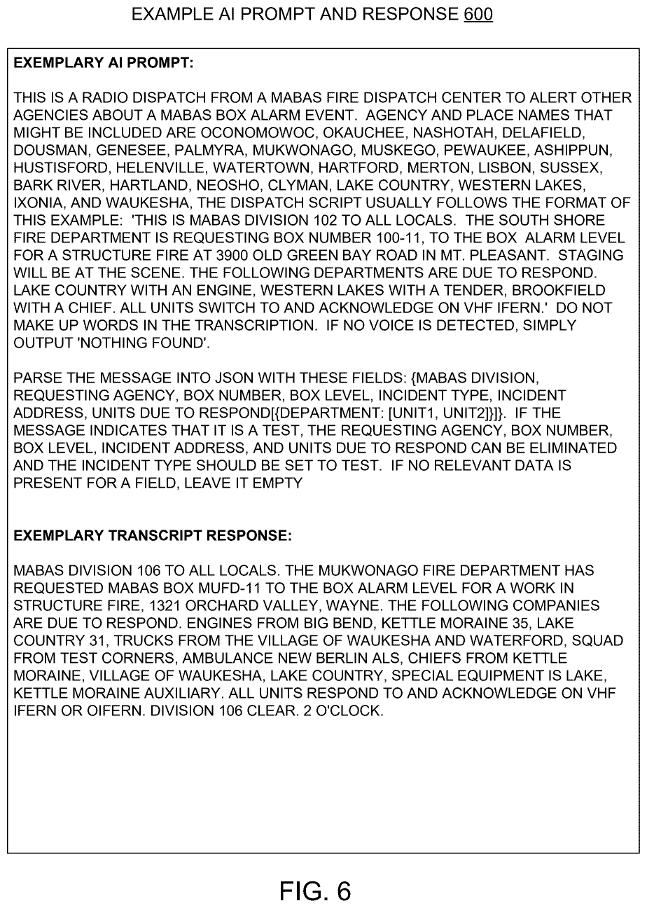

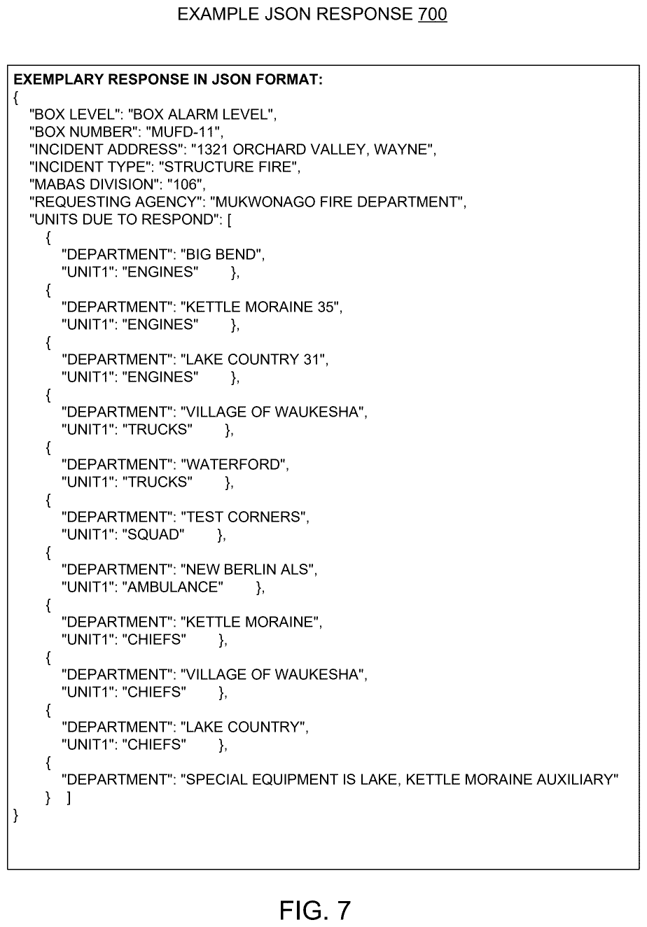

FIGS. 6 and 7 illustrate examples of AI prompt instructions and responses that may be provided by one or more disclosed systems and/or processes to generate content for emergency notifications for operations centers and field responders, in accordance with aspects of the disclosure. Example AI prompt 600 of FIG. 6 generally include a role of the AI model, key: value pair definitions for formatted input, instructions for receiving context data, required actions, actions to consider, phonetical instructions, phonetical variations, suggested patterns to check, priority considerations, and/or output formatting instructions, in accordance with embodiments of the disclosure. Furthermore, example response 700 of FIG. 7 may be formatted in accordance with a standardized format, such as JSON format. However, it should be noted that any alternative or additional data format to JSON may also be utilized, such as, but not limited to, XML, YAML, CSV, etc.

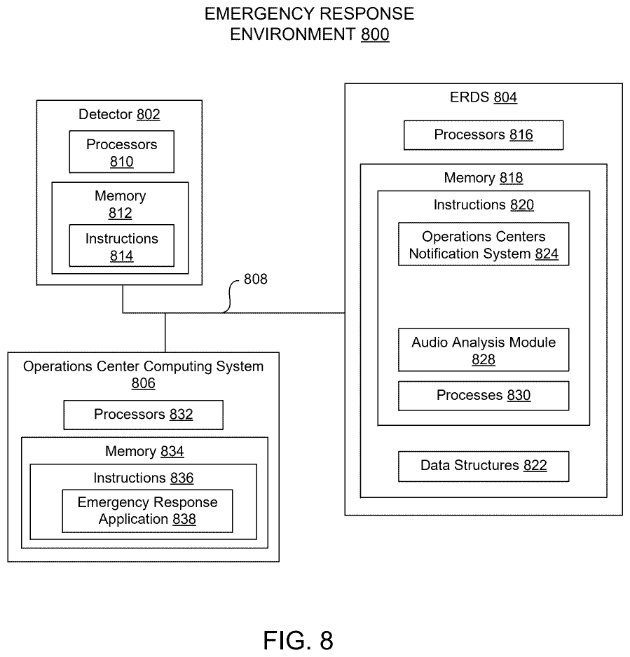

FIG. 8 illustrates an example diagram of an emergency response environment 800, in accordance with aspects of the disclosure. Emergency response environment 800 includes processing logic, (computer-readable) instructions, and data structures that may be employed by a detector 802, an emergency management system (ERDS) 804, and operations center computing system 806, according to an embodiment. Detector 802, ERDS 804, and operations center computing system 806 may be communicatively coupled to each other through one or more communication channels 808 (e.g., networks, wired or wireless networks, Internet, intranet, etc.), according to an embodiment.

Detector 802 is an example implementation of detector 270 (shown in FIG. 2), according to an embodiment. Detector 802 may include one or more processors 810 and memory 812. Memory 812 may include volatile and/or non-volatile memory. Memory 812 may store instructions 814 that may be executed by processors 810, according to an embodiment.

ERDS 804 may include processors 816, memory 818, and data structures 822, according to an embodiment. Memory 818 may include instructions 820 and data structures 822, according to an embodiment. Memory 818 may include volatile and/or non-volatile memory. Instructions 820 may be stored by memory 818 and may include operations centers notification system 824, an audio analysis module 828, and one or more processes 830, according to embodiments of the disclosure. Data structures 822 may store one or more databases used within one or more of the disclosed emergency response environments and/or emergency response data systems, according to an embodiment.

Operations center computing system 806 includes processors 832 and memory 834, according to an embodiment. Memory 834 may include instructions 836, and instructions 836 may include an emergency response application 838. Emergency response application 838 is representative of emergency response application 206 (shown in FIG. 2), according to an embodiment.

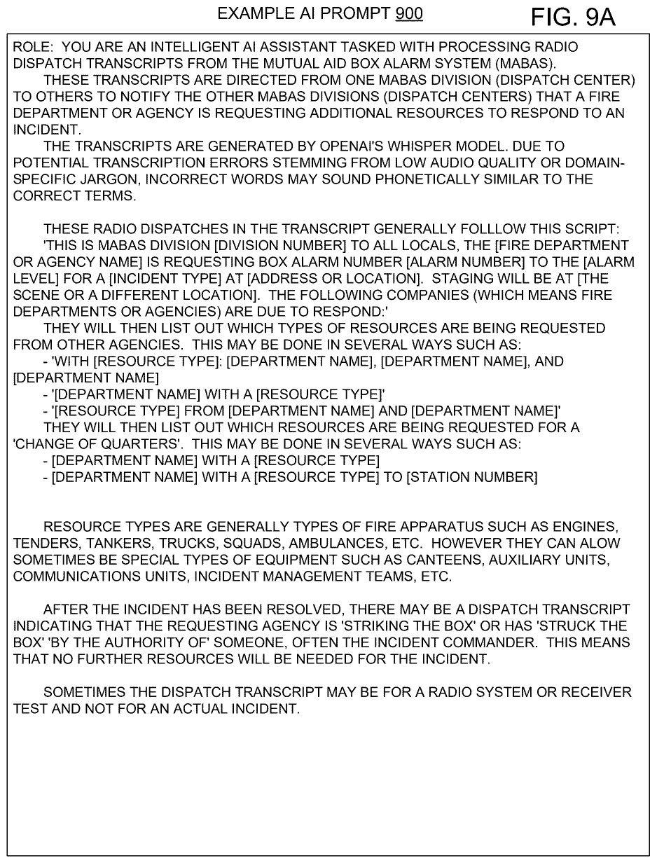

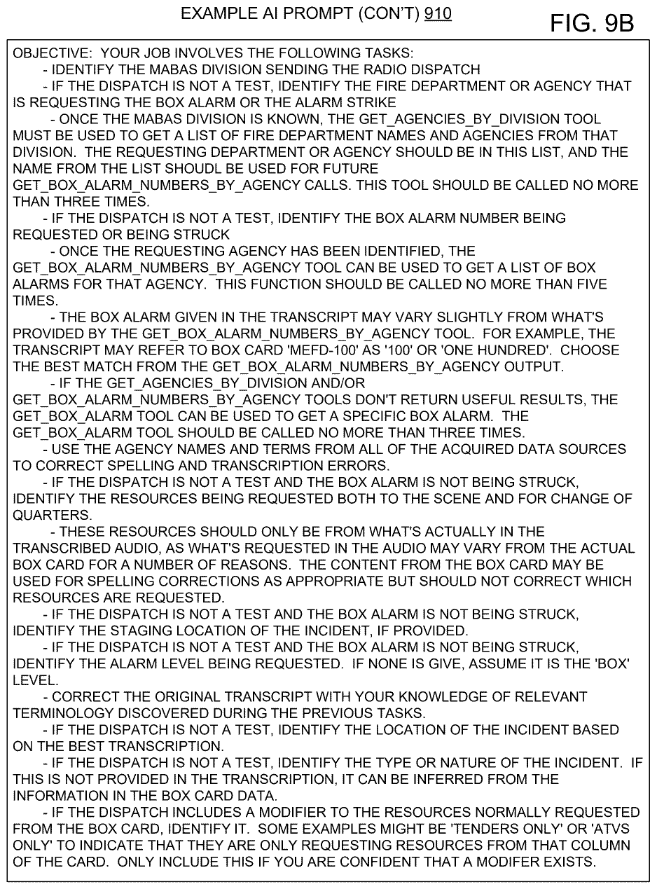

FIGS. 9A and 9B illustrate examples of additional AI prompt instructions that may be provided by one or more disclosed systems and/or processes to generate content for emergency notifications for operations centers, in accordance with aspects of the disclosure. Example AI prompts 900 and 901 of FIGS. 9A and 9B, respectively, generally include a role of the AI model, instructions for receiving context data, objective, required actions, actions to consider, and/or output formatting instructions, in accordance with embodiments of the disclosure.

While this disclosure contains many specific implementation details, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded with the widest scope consistent with this disclosure, the principles and the novel features disclosed herein.

The term “logic” and/or “processing logic” in this disclosure may include one or more processors, microprocessors, multi-core processors, application-specific integrated circuits (ASIC), and/or field programmable gate arrays (FPGAs) to execute operations disclosed herein. In some embodiments, memory may be integrated into the logic to store instructions to execute operations and/or store data. Logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application-specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An emergency response data system operable to provide artificial intelligence (AI)-based emergency notifications to a plurality of field responders, comprising:
memory having instructions;
one or more processors coupled to the memory and operable to execute the instructions to perform one or more operations, comprising:
receive audio data representative of a radio-based dispatch of emergency responders of an initiated emergency communication;
provide the audio data to an AI model with a first prompt to transcribe the audio data into a radio dispatch transcript;
provide the radio dispatch transcript to the AI model with a second prompt to analyze the radio dispatch transcript to extract activation notification content from the radio dispatch transcript;
receive operating instructions for the plurality of field responders based on the activation notification content, wherein a first set of operating instructions correlates to a first alarm level and a second set of operating instructions correlates to a second alarm level;
provide a first AI-based activation notification to an emergency response application that is operable to display the first set of operating instructions to a first field responder; and
provide a second AI-based activation notification to a further emergency response application that is operable to display the second set of operating instructions to a second field responders.

2. The emergency response data system of claim 1, wherein the radio-based dispatch is transmitted over at least one of very-high frequency (VHF) or ultra-high frequency (UHF) radio waves.

3. The emergency response data system of claim 1, wherein the activation notification content includes a plurality of alarm levels, wherein each alarm level corresponds to at least one of the field responders and at operating instructions.

4. The emergency response data system of claim 1, wherein the operating instructions includes at least one of personnel type, emergency resource types, vehicle type, special equipment, jurisdictions, and a notification to an additional field responder.

5. The emergency response data system of claim 1, wherein the emergency response application is operable to display one of the first and second operating instructions as a textual message including an address or description of a location of the initiated emergency communication.

6. The emergency response data system of claim 1, wherein the second AI-based activation notification is a pre-alert notification and the second alarm level is a next highest alarm level to the first alarm level.

7. The emergency response data system of claim 1, wherein the initiated emergency communication is a 911 call or a textual message to 911.

8. The emergency response data system of claim 1, wherein the one or more operations further include:
identify at least one error in the radio dispatch transcript; and
provide a corrected radio dispatch transcript to at least one of the first and second field responders.

9. A method of notifying a plurality of field responders of an initiated emergency communication, comprising:
receiving, with a cloud server, audio data representative of a radio-based dispatch of emergency responders to a location of the initiated emergency communication, wherein the initiated emergency communication includes a 911 call or a textual message to 911;
providing the audio data to a first artificial intelligence (AI) model;
prompting the first AI model to transcribe the audio data into a radio dispatch transcript;
searching the radio dispatch transcript for activation notification content;
receiving operating instructions for at least two of the plurality of field responders based on the activation notification content, wherein a first set of operating instructions correlates to a first alarm level and a second set of operating instructions correlates to a second alarm level;
providing a first AI-based activation notification to an emergency response application that is operable to display the first set of operating instructions to a first field responder; and
providing a second AI-based activation notification to a further emergency response application that is operable to display the second set of operating instructions to a second field responder.

10. The method of claim 9, wherein the activation notification content includes a plurality of alarm levels, wherein each alarm level corresponds to at least one of the field responders and at operating instructions.

11. The method of claim 9, wherein the operating instructions includes at least one of personnel type, emergency resource types, vehicle type, special equipment, jurisdictions, and a notification to an additional field responder.

12. The method of claim 9, wherein the emergency response application is operable to display one of the first and second operating instructions as a textual message including an address or description of the location of the initiated emergency communication.

13. The method of claim 9, wherein the second AI-based activation notification is a pre-alert notification and the second alarm level is a next highest alarm level to the first alarm level.

14. The method of claim 9, further comprising:
providing at least one the audio data and the radio dispatch transcript to at least one of the first and second field responders.

15. A method of notifying a plurality of field responders of an initiated emergency communication, comprising:
prompting an artificial intelligence (AI) model to extract activation notification content from a radio-based dispatch of emergency responders of an initiated emergency communication
receiving operating instructions for the plurality of field responders based on the activation notification content, wherein a first set of operating instructions correlates to a first alarm level and a second set of operating instructions correlates to a second alarm level;
provide a first AI-based activation notification to an emergency response application that is operable to display the first set of operating instructions to a first field responder; and
provide a second AI-based activation notification to a further emergency response application that is operable to display the second set of operating instructions to a second field responder.

16. The method of claim 15, wherein the activation notification content includes a plurality of alarm levels, wherein each alarm level corresponds to at least one of the field responders and at operating instructions.

17. The method of claim 15, wherein the operating instructions includes at least one of personnel type, emergency resource types, vehicle type, special equipment, jurisdictions, and a notification to an additional field responder.

18. The method of claim 15, wherein the emergency response application is operable to display one of the first and second operating instructions as a textual message including an address or description of a location of the initiated emergency communication.

19. The method of claim 15, wherein the second AI-based activation notification is a pre-alert notification and the second alarm level is a next highest alarm level to the first alarm level.

20. The method of claim 15, further comprising:
prompting the AI model to generate a radio dispatch transcript;
identifying at least one error in the radio dispatch transcript;
prompting the AI model to correct the at least one error; and
providing a corrected radio dispatch transcript to at least one of the first and second field responders.
